(19) United States
(12) Patent Application Publication
(10) Pub. No.: US 2020/0069509 A1
(43) Pub. Date: Mar. 5, 2020

(54) DRYING DEVICE

(71) Applicants: Jeffrey Frana, Temecula, CA (US); Douglas Forinash, Pflugerville, TX (US)

(72) Inventors: Jeffrey Frana, Temecula, CA (US); Douglas Forinash, Pflugerville, TX (US)

(21) Appl. No.: 16/552,942

(22) Filed: Aug. 27, 2019

Related U.S. Application Data
(60) Provisional application No. 62/724,770, filed on Aug. 30, 2018.
(60) Provisional application No. 62/752,246, filed on Oct. 29, 2018.

(51) Int. Cl. A61H 19/00; A47G 29/08; F26B 9/10

(52) U.S. Cl. CPC A61H 19/32; A47G 29/08; A47G 25/28; A61H 2201/0157; A61H 2201/0119; F26B 9/10

(57) ABSTRACT

A male masturbatory aid drying device is made up of a hoop portion capable of containing a male masturbatory aid case and/or insert for sanitary drying purposes.

### CROSS-REFERENCE TO RELATED APPLICATIONS

This application claims the benefit of U.S. Provisional Application No. 62/724,770 filed on Aug. 30, 2018 and U.S. Provisional Application No. 62/752,246 filed on Oct. 29, 2018, the teachings of which are expressly incorporated by reference.

### STATEMENT RE: FEDERALLY SPONSORED RESEARCH/DEVELOPMENT

Not Applicable

### BACKGROUND

The present disclosure relates generally to a drying device, and more particularly to a male masturbatory aid drying device. The drying devices disclosed herein are intended to allow for easy product care and discreet storage of male masturbatory aids.

Various male masturbatory aids are known in the art. Including, for example, the aid disclosed in U.S. Pat. No. 5,807,360. Attempts have been made in the past to make their storage discreet, such as making the outer casing of the device appear to be something else, such as a flashlight, can, bottle, or the like. However, these attempts have been of varying quality to truly hide what the device is. Further, they do not allow for discreet drying of the internal portions of the aids. As the internal portions of the device must be cleaned properly, and then air-dried, discreet storage during the drying process has not previously been addressed.

Users of male masturbatory aids all have to face two hurdles before and during ownership: 1) how do you clean it, and 2) where do you put it. Male masturbatory aids are offered to a wide variety of users—from partners looking to spice things up in the bedroom to individuals looking to bring their game to the next level with some one-on-one practice.

Owning a male masturbatory aid can be an exciting and fulfilling experience, yet for many the problem persists of how to care for the aid and where to put the aid when not in use. These products were designed to be used in private, yet the prior art has required that their cleaning and storage occur out in the open. More importantly, proper care (cleaning) of the aid is essential to ensure the aid is ready for its next use. For many users, leaving their male masturbatory aid on the bathroom countertop or in their room to dry between uses is unwanted at best, and, at certain times and in certain circumstances, simply not an option. Most users do not want roommates, parents, spouses, or houseguests to see the aid between uses.

In that regard, a typical male masturbatory aid typically comprises four components: an elastic insert, a rigid outer case, and removable screw caps on each end of the outer case. The insert is made from a synthetic skin-like material and is secured inside the outer case during use. The insert can be removed from the case for cleaning purposes. Commonly, the insert has an annular indentation at the user end which fits with a corresponding annular flange portion of the outer case, such that the insert is secured within the outer case during use. The insert is then typically removed from the outer case after use for cleaning and/or drying purposes.

As such, there is a need for a device capable of properly, and discreetly, storing and drying male masturbatory aids between uses.

### BRIEF SUMMARY

The present disclosure contemplates male masturbatory aid drying devices. In one embodiment, the drying device has a circular securing hoop, with a first rod attached at one point to the circular securing hoop. The first rod extends tangentially outward in both directions from the securing hoop and has a proximal end and a distal end. This embodiment further includes a second rod attached to the circular securing hoop at a point generally diametrically opposed to the first rod. The second rod also extends tangentially outward in both directions from the securing hoop and has a proximal end and a distal end, such that the first rod and second rod are generally parallel to each other. The first and second rods may further have bent portions at their proximal and distal ends.

The circular securing hoop may have a diameter between approximately two to approximately five inches. Additionally, this embodiment may include more than one circular securing hoops disposed between the first rod and the second rod. In certain embodiments, the circular securing hoops may be threaded.

In one embodiment, the drying device may further include a first folding section having an attachment portion and a second folding section having an attachment portion. The first folding section is rotatably attached to the first rod and the second folding section is rotatably attached to the second rod.

In another embodiment, the drying device has a circular securing hoop, a plurality of rods having proximal and distal ends, and a base portion. In this embodiment, the proximal ends of the plurality of rods are attached at approximately equidistant points around the circular securing hoop; and the distal ends of the plurality of rods are attached to the base portion.

The circular securing hoop may have a diameter between approximately two to approximately five inches. Further, the circular securing hoop may be threaded.

In certain embodiments, the plurality of rods may have a length of approximately nine inches to approximately twelve inches long. In one embodiment, the plurality of rods is made up of four rods.

The base portion may be made of a single, solid flat piece. In another embodiment, the base portion may be made of a plurality of base rods connected end to end. In yet another embodiment, the base portion is a cylindrical cup.

In yet another embodiment, the drying device has an attachment portion, a first rod having proximal and distal ends, a second rod having proximal and distal ends, and a circular securing hoop. In this embodiment, at least one of the first and second rods connect the attachment portion to the circular securing hoop. This embodiment may further include a first base rod disposed horizontally between the first rod and the circular securing hoop and a second base rod disposed horizontally between the second rod and the circular securing hoop.

In one embodiment, the attachment portion is a hook. In another embodiment, the attachment portion is a hoop.

In certain embodiments, the proximal end of the first rod is connected to the attachment portion and the distal end of the first rod is connected to the circular securing hoop. Further, in this embodiment, the proximal end of the second rod is connected to the attachment portion and the distal end of the second rod is connected to the circular securing hoop.

In another embodiment, the proximal end of the first rod is connected to the attachment portion and the distal end of the first rod is connected to the circular securing hoop. Further, in this embodiment, the proximal end of the second rod is connected to the first rod and the distal end of the second rod is connected to the circular securing hoop.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A is a perspective top view of one embodiment of a drying device of the present disclosure;

FIG. 1B is a side view of the drying device shown in FIG. 1A;

FIG. 1C is a top view of the drying device shown in FIG. 1A;

FIG. 1D is a perspective top view of the drying device shown in FIG. 1A with the male masturbatory aid insert in place;

FIG. 2A is a perspective top view of a second embodiment of a drying device of the present disclosure;

FIG. 2B is a side view of the drying device shown in FIG. 2A;

FIG. 2C is a top view of the drying device shown in FIG. 2A;

FIG. 2D is a perspective top view of the drying device shown in FIG. 2A with two male masturbatory aid inserts in place;

FIG. 3A is a perspective top view of a third embodiment of a drying device of the present disclosure;

FIG. 3B is a side view of the drying device shown in FIG. 3A;

FIG. 3C is a top view of the drying device shown in FIG. 3A;

FIG. 3D is a perspective top view of the drying device shown in FIG. 3A with one male masturbatory aid insert in place;

FIG. 4A is a perspective top view of a fourth embodiment of a drying device of the present disclosure;

FIG. 4B is a side view of the drying device shown in FIG. 4A;

FIG. 4C is a top view of the drying device shown in FIG. 4A;

FIG. 4D is a perspective top view of the drying device shown in FIG. 4A with a male masturbatory aid insert in place;

FIG. 5A is a perspective top view of a fifth embodiment of a drying device of the present disclosure;

FIG. 5B is a side view of the drying device shown in FIG. 5A;

FIG. 5C is a top view of the drying device shown in FIG. 5A;

FIG. 5D is a perspective top view of the drying device shown in FIG. 5A with a male masturbatory aid insert in place;

FIG. 6A is a perspective top view of a sixth embodiment of a drying device of the present disclosure;

FIG. 6B is a side view of the drying device shown in FIG. 6A;

FIG. 6C is a top view of the drying device shown in FIG. 6A when collapsed;

FIG. 6D is a perspective top view of the drying device shown in FIG. 6A with a male masturbatory aid insert in place;

FIG. 7A is a perspective top view of a seventh embodiment of a drying device of the present disclosure;

FIG. 7B is a side view of the drying device shown in FIG. 7A;

FIG. 7C is a top view of the drying device shown in FIG. 7A;

FIG. 7D is a perspective top view of the drying device shown in FIG. 7A with a male masturbatory aid insert in place;

FIG. 8A is a perspective top view of an eighth embodiment of a drying device of the present disclosure;

FIG. 8B is a side view of the drying device shown in FIG. 8A;

FIG. 8C is a top view of the drying device shown in FIG. 8A;

FIG. 8D is a perspective top view of the drying device shown in FIG. 8A with a male masturbatory aid in place;

FIG. 9A is a perspective top view of a ninth embodiment of a drying device of the present disclosure;

FIG. 9B is a side view of the drying device shown in FIG. 9A;

FIG. 9C is a top view of the drying device shown in FIG. 9A;

FIG. 9D is a perspective top view of the drying device shown in FIG. 9A with a male masturbatory aid insert in place;

FIG. 10A is a perspective top view of a tenth embodiment of a drying device of the present disclosure;

FIG. 10B is a side view of the drying device shown in FIG. 10A;

FIG. 10C is a top view of the drying device shown in FIG. 10A; and

FIG. 10D is a perspective top view of the drying device shown in FIG. 10A with a male masturbatory aid insert in place.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention. When discussing a “male masturbatory aid” it may be referring to either an insert, an outer case, or the insert contained within the outer case.

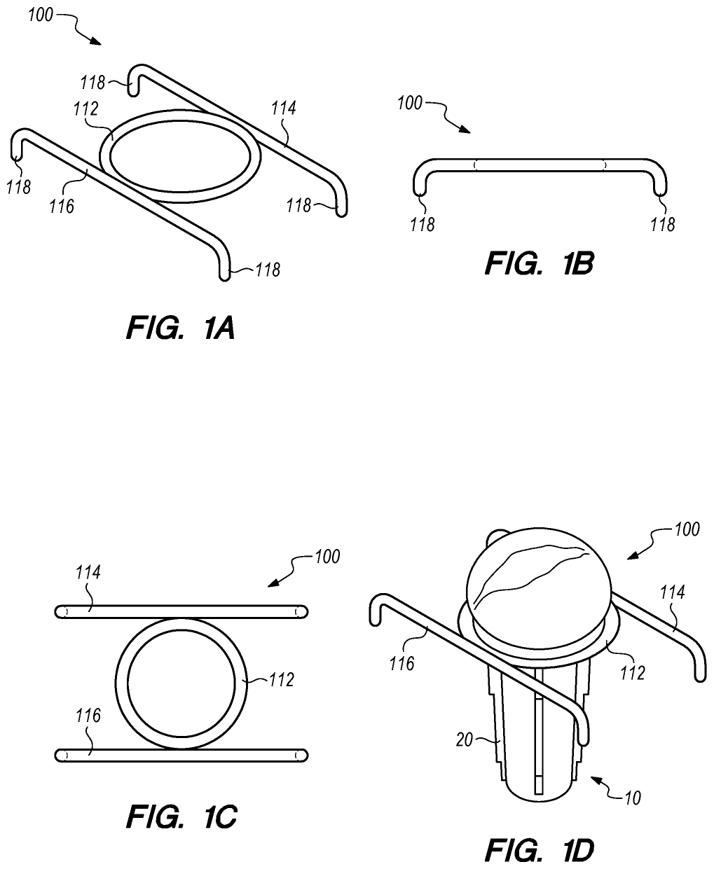

Referring to FIGS. 1A-1D, there is shown a first embodiment of a drying device of the present disclosure. In that regard, the drying device 100 is typically made out of injection molded plastic or metal and designed to hold a single male masturbatory aid 10 in an upright position between two standard-sized clothing hangers (not shown) for the purpose of post-use care/drying and discreet storage inside of a closet. The device 100 is flat in appearance with a single circular securing hoop 112 at the center (with a diameter of typically 2-5 inches) for the male masturbatory aid 10 to slide through and be held in place for convenient drying and storage.

As can be seen, the hoop 112 is attached at one point to a first rod 114 that extends tangentially outward in both directions from the hoop 112. A second rod 116 is attached to the hoop 112 at a point generally diametrically opposed to the first rod 114, such that the first rod 114 and second rod 116 are generally parallel to each other. The first and second rods 114, 116 each have a proximal end and a distal end. To that end, the first and second rods 114, 116 may include bent portions 118 at their respective proximal and distal ends. In use, the first and second rods 114, 116 can be set on the crossbeams of traditional clothes hangers (not shown), such that the device 100 rests on two clothes hangers. The bent portions 118 may aid in securing the device 100 to the clothes hangers such that the device 100 does not slip or fall from its placement on the clothes hangers during storage of the male masturbatory aid 10. Additionally, further tabs, rods, indentations, or other shapes (not shown) may be present on the first and second rods 114, 116 to assist in retaining the device 100 on the clothing hangers.

While the device 100 in FIG. 1D shows the storage of an insert 20 of a male masturbatory aid 10, the device 100 can also be utilized to store an outer case 22 of an aid 10, with or without the insert 20 being contained within the outer case 22. FIG. 1D shows the securing hoop 112 engaging with the annular indentation of the insert 20, to secure the insert 20 in place during storage.

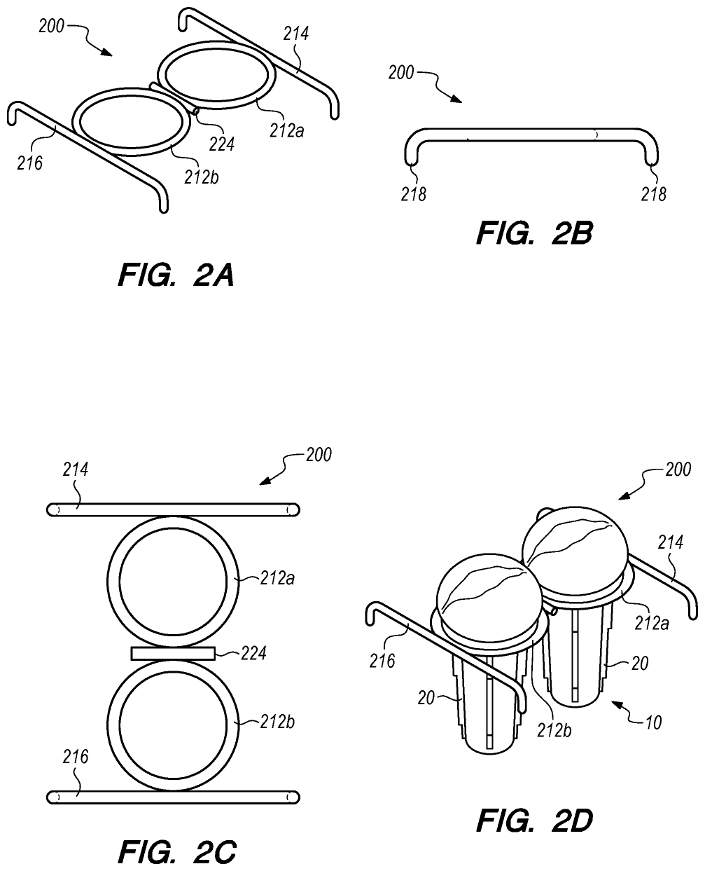

Referring to FIGS. 2A-2D, there is shown a second embodiment of a drying device of the present disclosure. In that regard, the drying device 200 is typically made out of injection molded plastic or metal and designed to hold two male masturbatory aids 10 in an upright position between two standard-sized clothing hangers (not shown) for the purpose of post-use care/drying and discreet storage inside of a closet. The device 200 is flat in appearance with two circular securing hoops 212a, 212b at the center (with a diameter of typically 2-5 inches) for the male masturbatory aids 10 to slide through and be held in place for convenient drying and storage. This embodiment is designed for users with two or more male masturbatory aids.

As can be seen, a first hoop 212a is attached at one point to a first rod 214 that extends tangentially outward in both directions from the first hoop 212a. A second hoop 212b is attached to the first hoop 212a at a contact point 224 generally diametrically opposed to the first rod 214. A second rod 216 is attached to a second hoop 212b at a point on the second hoop 212b generally diametrically opposed to the contact point 224, such that the first rod 214 and second rod 216 are generally parallel to each other. The first and second rods 214, 216 may include bent portions 218 at their ends. In use, the first and second rods 214, 216 can be set on the crossbeams of traditional clothes hangers (not shown), such that the device 200 rests on two clothes hangers. The bent portions 218 may aid in securing the device 200 to the clothes hangers such that the device 200 does not slip or fall from its placement on the clothes hangers during storage of the male masturbatory aids 10. Additionally, further tabs, rods, indentations, or other shapes (not shown) may be present on the first and second rods 114, 216 to assist in retaining the device 200 on the clothing hangers.

While the device 200 in FIG. 2D shows the storage of two inserts 20 of male masturbatory aids 10, the device 200 can also be utilized to store an outer case 22 of an aid 10, with or without the insert 20 being contained within the outer case 22. FIG. 2D shows the securing hoops 212a, b engaging with the annular indentation of two inserts 20, to secure the inserts 20 in place during storage. However, the device 200, could be utilized to secure an insert 20 in one hoop and an outer case 22 in the other hoop, or even two outer cases 22 in each hoop, with or without the inserts 20 contained within.

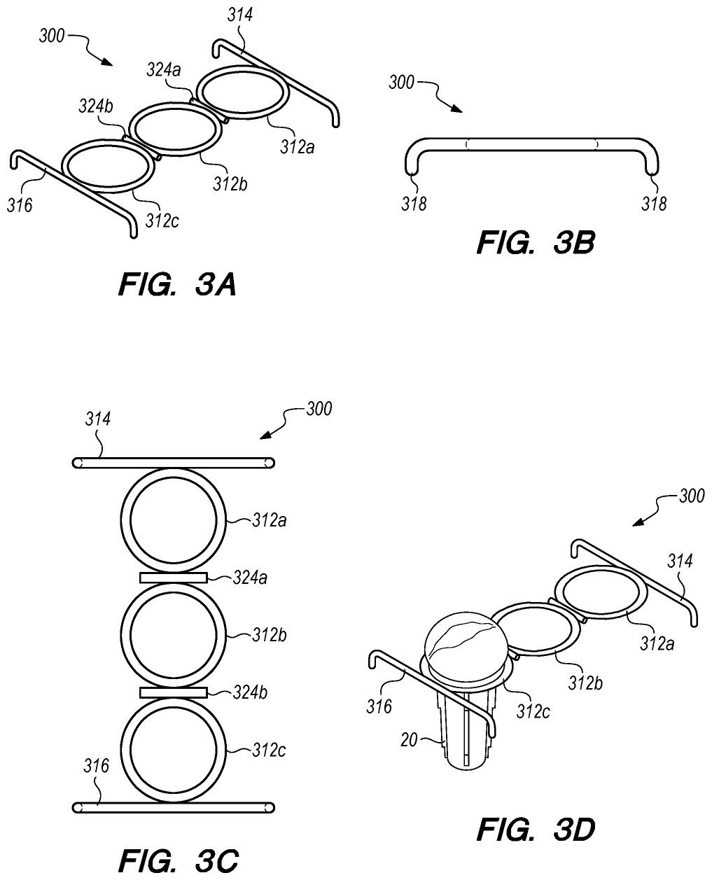

Referring to FIGS. 3A-3D, there is shown a third embodiment of a drying device of the present disclosure. In that regard, the drying device 300 is typically made out of injection molded plastic or metal and designed to hold three male masturbatory aids 10 in an upright position between two standard-sized clothing hangers (not shown) for the purpose of post-use care/drying and discreet storage inside of a closet. The device 300 is flat in appearance with three circular hoops 312a, 312b, 312c at the center (with a diameter of typically 2-5 inches) for the male masturbatory aids 10 to slide through and be held in place for convenient drying and storage. This embodiment is designed for users with multiple masturbatory aids.

As can be seen, a first hoop 312a is attached at one point to a first rod 314 that extends tangentially outward in both directions from the first hoop 312a. A second hoop 312b is attached to the first hoop 312a at a first contact point 324a generally diametrically opposed to the first rod 314. A third hoop 312c is attached to the second hoop 312b at a second contact point 324b generally diametrically opposed to the first contact point 324a. A second rod 316 is attached to the third hoop 312c at a point on the third hoop 312c generally diametrically opposed to the second contact point 324b, such that the first rod 314 and second rod 316 are generally parallel to each other. The first and second rods 314, 316 may include bent portions 318 at their ends. In use, the first and second rods 314, 316 can be set on the crossbeams of traditional clothes hangers (not shown), such that the device 300 rests on two clothes hangers. The bent portions 318 may aid in securing the device 300 to the clothes hangers such that the device 300 does not slip or fall from its placement on the clothes hangers during storage of the male masturbatory aids 10. Additionally, further tabs, rods, indentations, or other shapes (not shown) may be present on the first and second rods 314, 316 to assist in retaining the device 300 on the clothing hangers.

While the device 300 in FIG. 3D shows the storage of an insert 20 of a male masturbatory aid 10, the device 300 can also be utilized to store an outer case 22 of an aid 10, with or without the insert 20 being contained within the outer case 22. FIG. 3D shows the securing hoop 312c engaging with the annular indentation of an insert 20, to secure the insert 20 in place during storage. However, the device 300, could be utilized to secure an insert 20 in one or more hoops and an outer case 22 in another hoop or two, or even two or three outer cases 22 in each hoop, with or without the inserts 20 contained within.

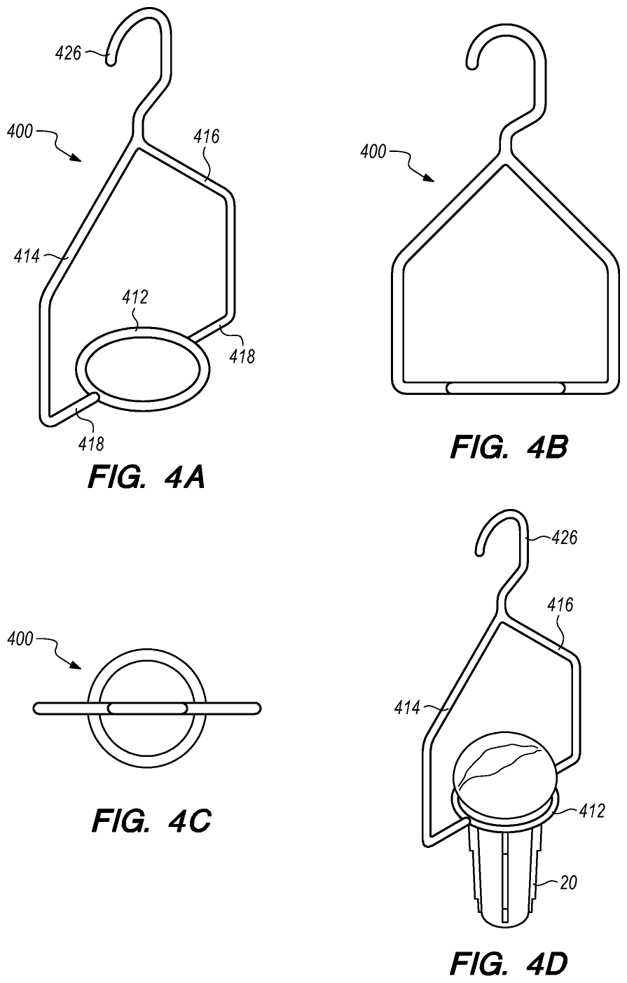

Referring to FIGS. 4A-4D, there is shown a fourth embodiment of a drying device of the present disclosure. In that regard, the drying device 400 is typically made out of injection molded plastic or metal and designed to hold a single male masturbatory aid 10 in an upright position suspended for drying and private storage, typically inside of a closet. The device 400 has a standard closet-rod-sized hook 426 at the top (similar to a standard clothing hanger). Extending downward from the hook 426 in an outwardly-angled position is a first rod 414. Additionally, there may be a second rod 416 extending downward from the hook 426 or the first rod 414 in an outwardly-angled position, such that the angle between the first rod 414 and the second rod 416 is greater than zero degrees and less than 180 degrees.

The first rod 414 and the second rod 416 are positionally generally in the same plane and taper down to attach on substantially diametrically opposed sides of a securing hoop 412. In certain embodiments there may only be the first rod 414, which will attach at one point to the hoop 412. The hoop 412 has a diameter of typically 2-5 inches for a male masturbatory aid 10 to slide through and be held in place for convenient drying and storage.

The first rod 414 and second rod 416 may be formed from a unitary piece of material with the hook 426, or they may be individual pieces that are attached to each other. Further, the first rod 414 and the second rod 416 may attach directly to the hoop 412, or may have short bent portions 418 at their terminal ends that attach to the hoop 412.

The drying device 400 is designed to hold a single male masturbatory insert 20 or case 22 (with or without insert within it) in a standard closet or similar setting to conceal the masturbatory device 10 for drying and storage. While the device 400 in FIG. 4D shows the storage of an insert 20 of a male masturbatory aid 10, the device 400 can also be utilized to store an outer case 22 of an aid 10, with or without the insert 20 being contained within the outer case 22. FIG. 4D shows the securing hoop 412 engaging with the annular indentation of an insert 20, to secure the insert 20 in place during storage. However, the device 400, could be utilized to secure an outer case 22 in the hoop instead, with or without the inserts 20 contained within. For example, the hoop 412 may have notches or threading to interact with and secure the outer case 22 in place.

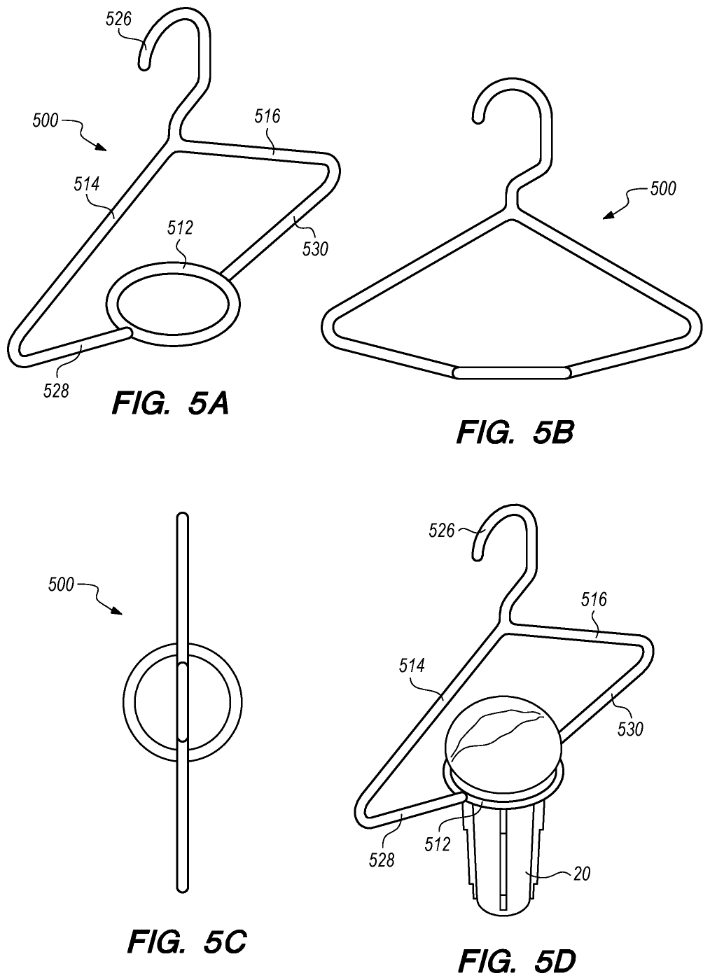

Referring to FIGS. 5A-5D, there is shown a fifth embodiment of a drying device of the present disclosure. In that regard, the drying device 500 is typically made out of injection molded plastic or metal and designed to hold a single male masturbatory aid 10 in an upright position suspended for drying and private storage, typically inside of a closet. The device 500 resembles a standard clothing hanger with a standard closet-rod-sized hook 526 at the top and a wide base portion capable of holding a piece of clothing. Extending downward from the hook 526 in an outwardly-angled position is a first rod 514. Additionally, a second rod 516 extends downward from the hook 526 or the first rod 514 in an outwardly-angled position, such that the angle between the first rod 514 and the second rod 516 is greater than zero degrees and less than 180 degrees. The angle is greater in this embodiment than that shown and described above in relation to FIGS. 4A-4D.

The first rod 514 and the second rod 516 are positionally generally in the same plane and taper down and outwardly away from each other. The first rod 514 attaches at its distal end to a first base rod 528 that extends inwardly in a generally horizontal or downwardly angled fashion. Likewise, the second rod 516 attaches at its distal end to a second base rod 530 that extends inwardly in a generally horizontal or downwardly angled fashion. The first base rod 528 and second base rod 530 attach on substantially diametrically opposed sides of a securing hoop 512. In certain embodiments there may be more than one hoop 512 positioned between the first base rod 528 and the second base rod 530. The hoop 512 has a diameter of typically 2-5 inches for a male masturbatory aid 10 to slide through and be held in place for convenient drying and storage.

The first rod 514, second rod 516, first base rod 528, and second base rod 530 may be formed from a unitary piece of material with the hook 526, or they may be made up of separate or individual pieces that are attached to each other. Further, the hoop 512 may be made from this unitary piece, or be its own piece attached to the first and second base rods 528, 530.

The drying device 500 is designed to hold a single (or multiple) male masturbatory insert 20 or case 22 (with or without insert within it) in a standard closet or similar setting and also hold a t-shirt, sweatshirt, or similar article of clothing over the masturbatory aid 10 to further conceal the aid 10 for drying and storage. While the device 500 in FIG. 5D shows the storage of an insert 20 of a male masturbatory aid 10, the device 500 can also be utilized to store an outer case 22 of an aid 10, with or without the insert 20 being contained within the outer case 22. FIG. 5D shows the securing hoop 512 engaging with the annular indentation of an insert 20, to secure the insert 20 in place during storage. However, the device 500, could be utilized to secure an outer case 22 in the hoop instead, with or without the inserts 20 contained within. For example, the hoop 512 may have notches or threading to interact with and secure the outer case 22 in place.

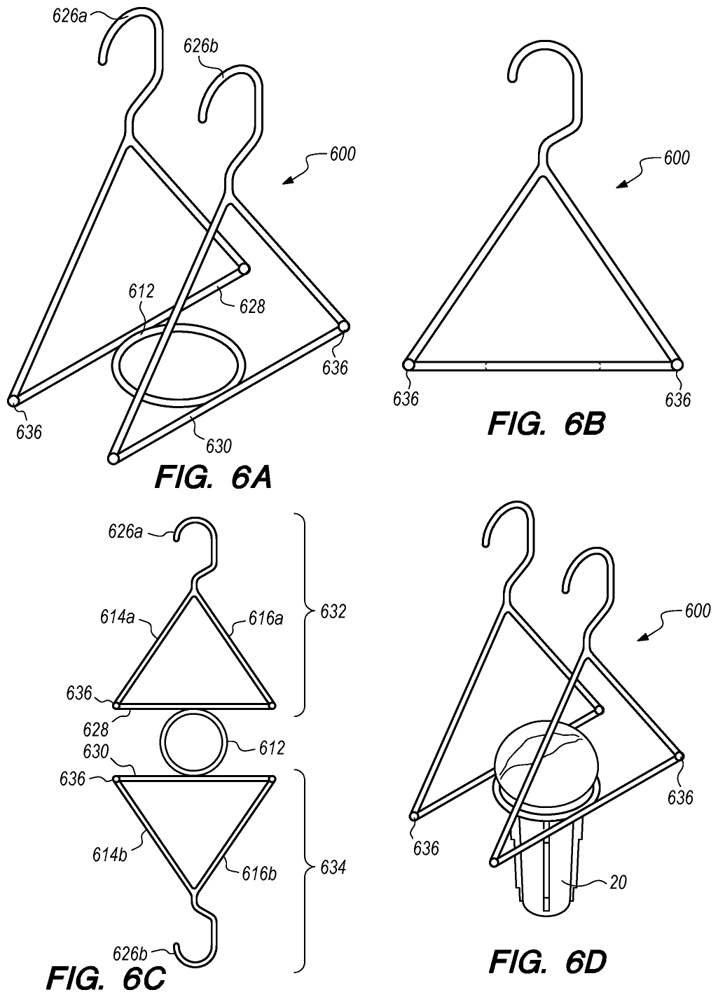

Referring to FIGS. 6A-6D, there is shown a sixth embodiment of a drying device of the present disclosure. In that regard, the drying device 600 is typically made out of injection molded plastic or metal and designed to hold a single male masturbatory aid 10 in an upright position suspended for drying and private storage, typically inside of a closet or from a similar raised hanging surface (doorway, etc.).

The device 600 has a single circular securing hoop 612 at its center (with a diameter of typically 2-5 inches) for the male masturbatory aid 10 to slide through and be held in place for convenient drying and storage. As can be seen, the hoop 612 is attached at one point to a first base rod 628 that extends tangentially outward in both directions from the hoop 612. A second base rod 630 is attached to the hoop 612 at a point generally diametrically opposed to the first base rod 628, such that the first base rod 628 and second base rod 630 are generally parallel to each other.

The device 600 further has a first folding section 632 rotatably attached to the first base rod 628. The first folding section 632 has a standard closet-rod-sized hook 626a at the top (similar to a standard clothing hanger). Extending downward from the hook 626a in an outwardly-angled position is a first rod 614a. Additionally, there may be a second rod 616a extending downward from the hook 626a or the first rod 614a in an outwardly-angled position, such that the angle between the first rod 614a and the second rod 616a is greater than zero degrees and less than 180 degrees. The first rod 614a and the second rod 616a are positioned generally in the same plane and taper down away from each other. Distal points of the first rod 614a and the second rod 616a attach to distal points of the first base rod 628 via hinging mechanisms 636, such as clip-on hooks.

The device 600 further has a second folding section 634 that substantially mirrors the first folding section 632. In particular, the second folding section 634 is rotatably attached to the second base rod 630. The second folding section 634 has a standard closet-rod-sized hook 626b at the top (similar to a standard clothing hanger). Extending downward from the hook 626b in an outwardly-angled position is a first rod 614b. Additionally, there may be a second rod 616b extending downward from the hook 626b or the first rod 614b in an outwardly-angled position, such that the angle between the first rod 614b and the second rod 616b is greater than zero degrees and less than 180 degrees. The first rod 614b and the second rod 616b are positioned generally in the same plane and taper down away from each other. Distal points of the first rod 614b and the second rod 616b attach to distal points of the second base rod 630 via hinging mechanisms 636, such as clip-on hooks.

As shown in FIG. 6C, the device 600 lays flat when in an “open” position, for storage and/or transport. The first folding section 632 and second folding section 634 can be raised into vertical positions for use (as shown in FIG. 6D). When in the vertical position, the device 600 is designed to hold a single male masturbatory aid 10 in its upright position to allow proper airflow for drying as well as concealed storage from within a closet or similar setting.

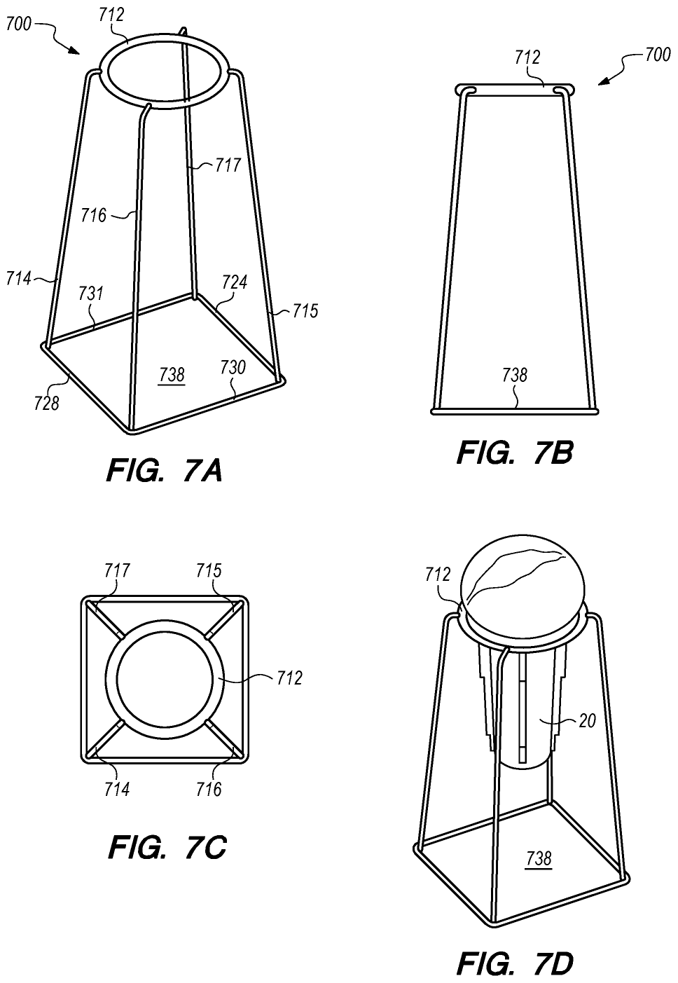

Referring to FIGS. 7A-7D, there is shown a seventh embodiment of a drying device of the present disclosure. In that regard, the drying device 700 is typically made out of injection molded plastic or metal and designed to hold a single male masturbatory aid 10 in an upright position on a horizontal surface for the purpose of post use care/drying. The device 700 has a single circular securing hoop 712 at the center (with a diameter of typically 2-5 inches) for the male masturbatory aid 10 to slide through and be held in place for convenient and sanitary drying purposes.

As can be seen, the hoop 712 is attached at one point to a proximal end of a first rod 714. The first rod 714 extends away from the hoop 712 in an angled, downwardly fashion. A distal end of the first rod 714 attaches to a base portion 738. As can be seen in the figures, a second rod 716, a third rod 715, and a fourth rod 717, are similarly attached at their respective proximal ends around the hoop 712 and at their respective distal ends to the base portion 738. The rods 714, 715, 716, 717 can be of any suitable length, but are typically between 9-12 inches long. As shown in FIGS. 7A-7D, four rods are used to create a square base portion 738, however, it is envisioned that any number of rods beyond two may be utilized to form the drying device 700.

As shown in the figures, the base portion 738 may comprise a first base rod 728 connected on one end to a second base rod 730 on one end and connected to a fourth base rod 731 on its other end, with a third base rod 724 likewise connecting the second 730 and fourth 731 base rods to create an open square base portion 738. Alternatively, however, the base portion 738 could be formed from a solid, flat piece rather than from four rod portions.

While the device 700 in FIG. 7D shows the storage of an insert 20 of a male masturbatory aid 10, the device 700 can also be utilized to store an outer case 22 of an aid 10, with or without the insert 20 being contained within the outer case 22. FIG. 7D shows the securing hoop 112 engaging with the annular indentation of the insert 20, to secure the insert 20 in place during storage.

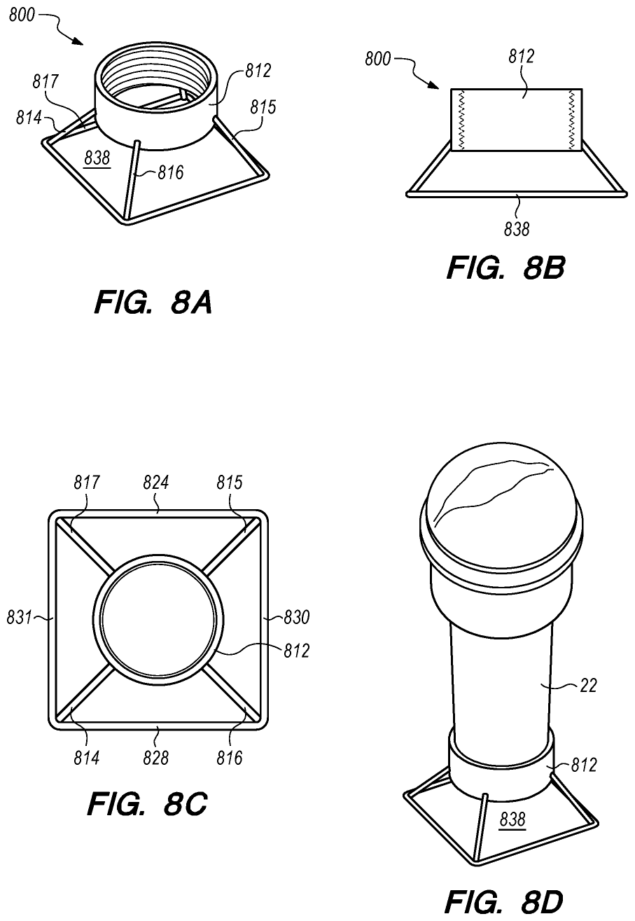

Referring to FIGS. 8A-8D, there is shown an eighth embodiment of a drying device of the present disclosure. In that regard, the drying device 800 is typically made out of injection molded plastic or metal and designed to hold a single male masturbatory aid 10 in an upright position on a horizontal surface for the purpose of post use care/drying. This embodiment is designed to remain fixed to the outer case 22 of the male masturbatory aid 10 without interfering with operation, or it can easily be removed at the user's desire. Alternatively to being a removable, separate piece, this embodiment (as well as others disclosed herein) can be integrally constructed within the outer case 22.

The device 800 has a single circular threaded hoop 812 at the center (with a diameter of typically 2-5 inches) for the outer case 22 to thread into and be held in place for convenient and sanitary drying purposes and/or during use of the aid 10. As can be seen, the hoop 812 is attached at one point to a proximal end of a first rod 814. The first rod 814 extends away from the hoop 812 in an angled, downwardly fashion. A distal end of the first rod 814 attaches to a base portion 838. As can be seen in the figures, a second rod 816, a third rod 815, and a fourth rod 817, are similarly attached at their respective proximal ends around the hoop 812 and at their respective distal ends to the base portion 838. As shown in FIGS. 8A-8D, four rods are used to create a square base portion 838, however, it is envisioned that any number of rods beyond two may be utilized to form the drying device 800.

As shown in the figures, the base portion 838 may comprise a first base rod 828 connected on one end to a second base rod 830 on one end and connected to a fourth base rod 831 on its other end, with a third base rod 824 likewise connecting the second 830 and fourth 831 base rods to create an open square base portion 838. Alternatively, however, the base portion 838 could be formed from a solid, flat piece rather than from four rod portions. Additionally, the base

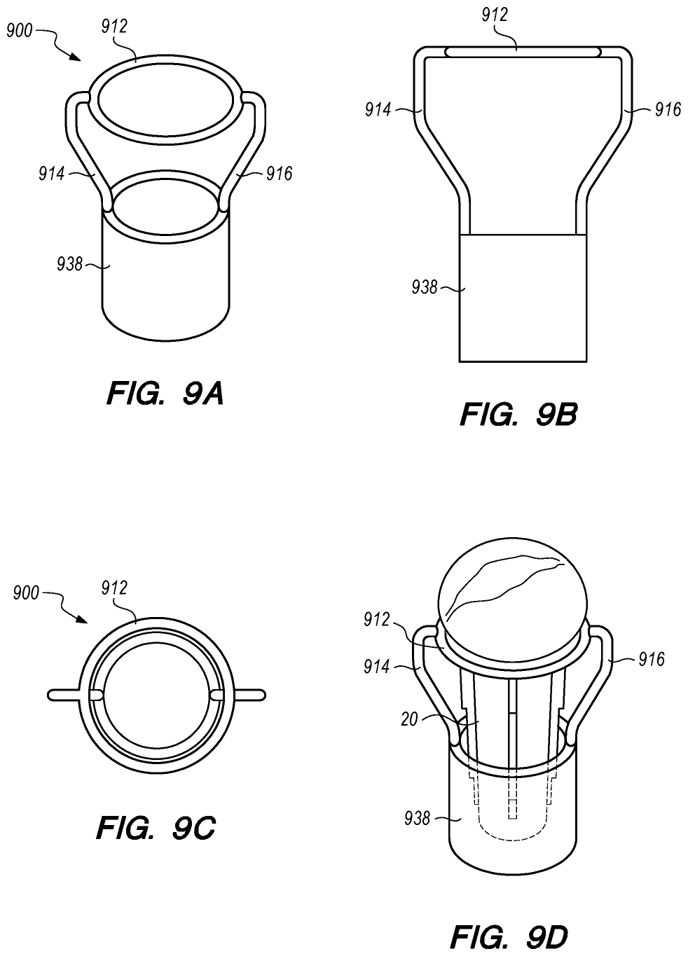

Referring to FIGS. 9A-9D, there is shown a ninth embodiment of a drying device of the present disclosure. In that regard, the drying device 900 is typically made out of injection molded plastic or metal and designed to hold a single male masturbatory aid 10 in an upright suspended position securely in an automotive-style cup holder for the purpose of post use care/drying. The device 900 has a single circular securing hoop 912 at the center (with a diameter of typically 2-5 inches) for the male masturbatory aid 10 to slide through and be held in place for convenient and sanitary drying purposes.

As can be seen, the hoop 912 is attached at one point to a proximal end of a first rod 914. The first rod 914 extends away from the hoop 912 in a downwardly fashion. A distal end of the first rod 914 attaches to a cylindrical base portion 938. As can be seen in the figures, a second rod 916 is similarly attached at its proximal end to the hoop 912 at approximately the diametrically opposite side from the first rod 914 and is similarly attached at its distal end to the base portion 938. The rods 914, 916 can be of any suitable length, but are typically between 9-12 inches long. While the figures show the use of two rods, it is envisioned that more than two rods could be utilized for greater structural strength and stability as desired.

As shown in the figures, the base portion 938 is a cylindrically shaped cup, with an opening at its top, and is closed at its bottom. With this configuration, the aid 10 receives adequate airflow to aid in drying, and further allows the “cup” of the base portion 938 to collect any dripping fluids while the device 10 dries. The base portion 938 can be of any suitable size but is preferably sized and shaped to fit within a standard sized automotive or aviation cup holder for travel purposes.

While the device 900 in FIG. 9D shows the storage of an insert 20 of a male masturbatory aid 10, the device 900 can also be utilized to store an outer case 22 of an aid 10, with or without the insert 20 being contained within the outer case 22. FIG. 9D shows the securing hoop 912 engaging with the annular indentation of the insert 20, to secure the insert 20 in place during storage.

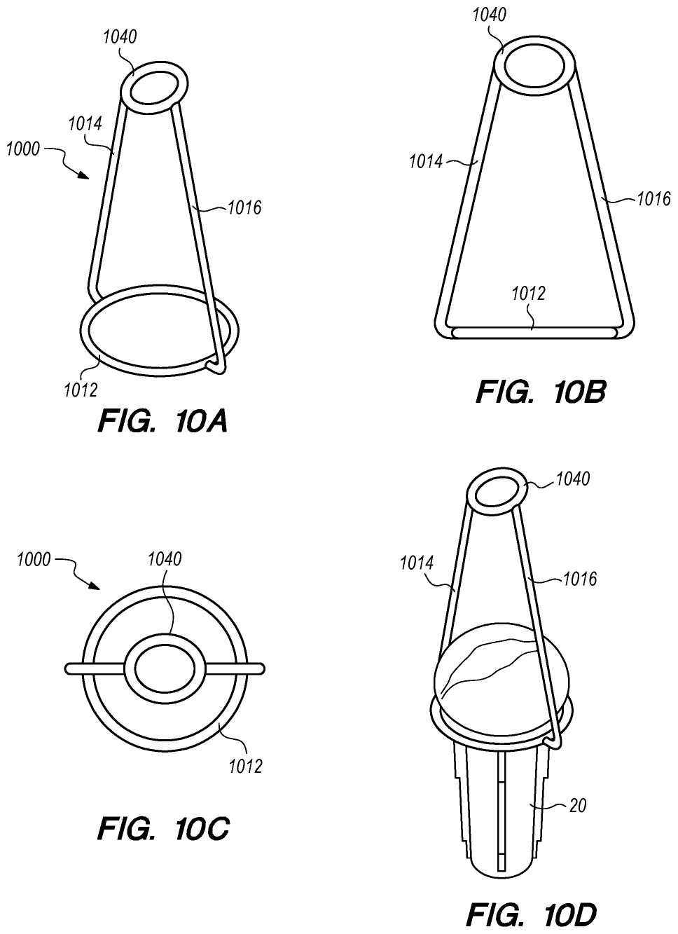

Referring to FIGS. 10A-10D, there is shown a tenth embodiment of a drying device of the present disclosure. In that regard, the drying device 1000 is typically made out of injection molded plastic, rubber, or metal and designed to hold a single male masturbatory aid 10 in an upright suspended position while attached to a standard-sized clothing hanger (not shown) for the purpose of post-use care/drying and discreet storage inside of a closet. The device 1000 has an attachment hoop 1040 at the top (with a diameter of typically 0.3-1.5 inches) and a circular securing hoop 1012 at the bottom (with a diameter of typically 2-5 inches) for the male masturbatory aid 10 to slide through and be held in place for convenient drying and storage.

As can be seen, the attachment hoop 1040 is attached at one point to a proximal end of a first rod 1014 that extends downward from the attachment hoop 1040. A proximal end of a second rod 1016 is attached to the attachment hoop 1040 at a point generally diametrically opposed to the first rod 1014, such that the first rod 1014 and second rod 1016 are generally on opposite sides of the attachment hoop 1040 to each other. The first and second rods 1014, 1016 are attached at their distal ends to the securing hoop 1012 at generally diametrically opposed sides. In use, the attachment hoop 1040 can be slid over the hook portion of a traditional clothes hanger (not shown), such that the device 1000 is supported by the clothes hanger. While discussed as being useful for attaching to the hook portion of a clothes hanger, the device 1000 should be understood to be capable of attaching to any similarly sized object via its attachment hoop 1040, such as a furniture knob, rod, protrusion, door knob, hook, or the like.

The rods 1014, 1016 may be any appropriate length, but are typically about 6-15 inches long. When the device 1000 is in place on a clothes hangar, the rods 1014, 1016 lay flat against the hanger to stabilize the device 1000 in place. Furthermore, a t-shirt, sweatshirt, or similar article of clothing may be placed over the clothes hangar as well to further conceal the aid 10 during drying and storage.

While the device 1000 in FIG. 10D shows the storage of an insert 20 of a male masturbatory aid 10, the device 1000 can also be utilized to store an outer case 22 of an aid 10, with or without the insert 20 being contained within the outer case 22. FIG. 10D shows the securing hoop 1012 engaging with the annular indentation of the insert 20, to secure the insert 20 in place during storage.

The above description is given by way of example, and not limitation. Given the above disclosure, one skilled in the art could devise variations that are within the scope and spirit of the invention disclosed herein, including securing either the insert alone, or the insert contained within the outer case to the drying rack. Furthermore, while several of the embodiments shown in the figures utilize a smooth securing hoop, it is envisioned that these securing hoops could alternatively be notched or threaded to retain either the insert or the outer case, and the device can be used with the outer case being stored either right-side up or upside down. Additionally, the device can be crafted from any suitable material, such as plastic, metal, wood, rubber, and the like. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A male masturbatory aid drying device comprising:
a circular securing hoop;
a first rod attached at one point to the circular securing hoop, said first rod extending tangentially outward in both directions from the securing hoop and having a proximal end and a distal end;
a second rod attached to the circular securing hoop at a point generally diametrically opposed to the first rod, said second rod extending tangentially outward in both directions from the securing hoop and having a proximal end and a distal end;
wherein the first rod and second rod are generally parallel to each other.

2. The drying device of claim 1, wherein the circular securing hoop has a diameter between approximately two to approximately five inches.

3. The drying device of claim 1, wherein the first and second rods further include bent portions at their proximal and distal ends.

4. The drying device of claim 1, further comprising at least one more circular securing hoop disposed between the first rod and the second rod.

5. The drying device of claim 1, wherein the circular securing hoop is threaded.

6. The drying device of claim 1, further comprising:
a first folding section having an attachment portion, wherein the first folding section is rotatably attached to the first rod; and
a second folding section having an attachment portion, wherein the second folding section is rotatably attached to the second rod.

7. A male masturbatory aid drying device comprising:
a circular securing hoop;
a plurality of rods having proximal and distal ends; and
a base portion;
wherein the proximal ends of the plurality of rods are attached at approximately equidistant points around the circular securing hoop; and
wherein the distal ends of the plurality of rods are attached to the base portion.

8. The drying device of claim 7, wherein the circular securing hoop has a diameter between approximately two to approximately five inches.

9. The drying device of claim 7, wherein the circular securing hoop is threaded.

10. The drying device of claim 7, wherein the plurality of rods has a length of approximately nine inches to approximately twelve inches long.

11. The drying device of claim 7, wherein the plurality of rods comprises four rods.

12. The drying device of claim 7, wherein the base portion comprises a single, solid flat piece.

13. The drying device of claim 7, wherein the base portion comprises a plurality of base rods connected end to end.

14. The drying device of claim 7, wherein the base portion is a cylindrical cup.

15. A male masturbatory aid drying device comprising:
an attachment portion;
a first rod having proximal and distal ends;
a second rod having proximal and distal ends; and
a circular securing hoop;
wherein at least one of the first and second rods connect the attachment portion to the circular securing hoop.

16. The drying device of claim 15, wherein the attachment portion is a hook.

17. The drying device of claim 15, wherein the attachment portion is a hoop.

18. The drying device of claim 15, wherein the proximal end of the first rod is connected to the attachment portion and the distal end of the first rod is connected to the circular securing hoop, and wherein the proximal end of the second rod is connected to the attachment portion and the distal end of the second rod is connected to the circular securing hoop.

19. The drying device of claim 15, wherein the proximal end of the first rod is connected to the attachment portion and the distal end of the first rod is connected to the circular securing hoop, and wherein the proximal end of the second rod is connected to the first rod and the distal end of the second rod is connected to the circular securing hoop.

20. The drying device of claim 15, further comprising:
a first base rod disposed horizontally between the first rod and the circular securing hoop; and
a second base rod disposed horizontally between the second rod and the circular securing hoop.
